(19) United States
(12) Patent Application Publication
(10) Pub. No.: US 2013/0075961 A1
(43) Pub. Date: Mar. 28, 2013

(54) Method for Making a Shock-Absorptive Material from a Micro- or Nano-Colloidal Solution

(71) Applicants: Chun-Ho Chen, Taipei (TW); Chun-Wei Chiu, New Taipei City (TW); Tsai-Chi Yeh, New Taipei City (TW)

(72) Inventors: Chun-Ho Chen, Taipei (TW); Chun-Wei Chiu, New Taipei City (TW); Tsai-Chi Yeh, New Taipei City (TW)

(73) Assignee: Chung-Shan Institute of Science and Technology, Amaments, Bureau, Ministry of National Defense, Taoyuan County (TW)

(21) Appl. No.: 13/244,341

(22) Filed: Sep. 24, 2011

(51) Int. Cl. B29C 35/08

(52) U.S. Cl. 264/496

(57) ABSTRACT

Disclosed is an efficient and inexpensive method for making an effective shock-absorptive material from a micro- or nano-colloidal solution. The method includes the steps of providing a liquid mixture via mixing silicon dioxide grains, poly ethylene glycol and an additive evenly, providing a colloidal solution-based raw material via heating the liquid mixture to evaporating and removing the additive, providing a colloidal solution-based mixture via adding a cross-linking agent into the colloidal solution-based raw material, and molding the colloidal solution-based mixture into a shock-absorptive plastic material via filling the colloidal solution-based mixture in a mold and casting ultraviolet light onto the mold or heating the mold to heat and cure the colloidal solution-based mixture.

### BACKGROUND OF INVENTION

1. Field of Invention

The present invention relates to a micro- or nano-colloidal solution and, more particularly, to an efficient and inexpensive method for making an effective shock-absorptive material from a micro- or nano-colloidal solution.

2. Related Prior Art

A micro- or nano-colloidal solution is normally in the form of a fluid. In use, the micro- or nano-colloidal solution is coated on a carrier. Hence, the weight or volume percentage of the micro- or nano-colloidal solution is low, i.e., 20% wt at most.

To our best understanding, there has not been any process for integrating the design of a micro- or nano-colloidal solution, the manufacturing of the micro- or nano-colloidal solution and the testing of the micro- or nano-colloidal solution. Therefore, micro- or nano-colloidal solutions cannot be used for shock absorption.

The present invention is therefore intended to obviate or at least alleviate the problems encountered in prior art.

### SUMMARY OF INVENTION

It is the primary objective of the present invention to provide an efficient and inexpensive method for making an effective shock-absorptive material from a micro- or nano-colloidal solution without having to coat the micro- or nano-colloidal solution on any carrier.

To achieve the foregoing objective, the method includes the steps of providing a liquid mixture via mixing silicon dioxide grains, poly ethylene glycol and an additive evenly, providing a colloidal solution-based raw material via heating the liquid mixture to evaporating and removing the additive, providing a colloidal solution-based mixture via adding a cross-linking agent into the colloidal solution-based raw material, and molding the colloidal solution-based mixture into a shock-absorptive plastic material via filling the colloidal solution-based mixture in a mold and heating the mold to heat and cure the colloidal solution-based mixture.

In another aspect, the silicon dioxide grains are made with a diameter of 50 nanometers to 500 micrometers.

In another aspect, the poly ethylene glycol is made with a molecular weight of 400 to 6000.

In another aspect, the additive is selected from the group consisting of ethanol or propanol.

In another aspect, the silicon dioxide grains are mixed with the poly ethylene glycol at a ratio of 20% wt to 60% wt.

In another aspect, the cross-linking agent is an acrylic monomer or a polymer.

In another aspect, the mold is made of metal that stands 200 degrees centigrade to 350 degrees centigrade.

In another aspect, the step of molding the colloidal solution-based mixture into the shock-absorptive plastic material includes the step of executing passivation on the mold to facilitate later release of the shock-absorptive plastic material from the mold.

In another aspect, the step of molding the colloidal solution-based mixture into the shock-absorptive plastic material includes the step of casting ultraviolet light onto the mold or to heat the mold to 150 degrees centigrade to 190 degrees centigrade for 1 to 2 hours.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a first step of an efficient and inexpensive method for making an effective shock-absorptive material from a micro- or nano-colloidal solution according to the preferred embodiment of the present invention;

FIG. 2 is a flow chart of a second step of an efficient and inexpensive method for making an effective shock-absorptive material from a micro- or nano-colloidal solution according to the preferred embodiment of the present invention;

FIG. 3 is a flow chart of a third step of an efficient and inexpensive method for making an effective shock-absorptive material from a micro- or nano-colloidal solution according to the preferred embodiment of the present invention; and

FIG. 4 is a flow chart of a fourth step of an efficient and inexpensive method for making an effective shock-absorptive material from a micro- or nano-colloidal solution according to the preferred embodiment of the present invention.

### DETAILED DESCRIPTION OF PREFERRED EMBODIMENT

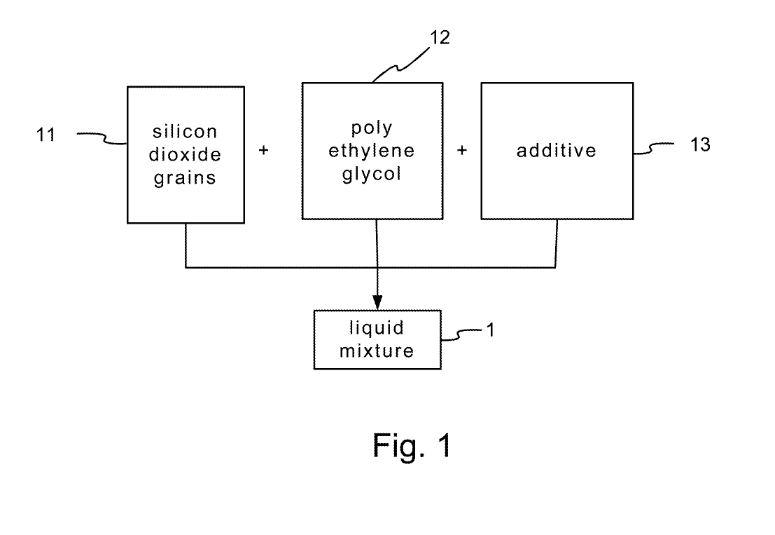

Referring to FIGS. 1 to 4, there is shown an efficient and inexpensive method for making an effective shock-absorptive plastic material from a micro- or nano-colloidal solution according to the preferred embodiment of the present invention. The method includes four steps shown in FIGS. 1 to 4, respectively.

Referring to FIG. 1, there are provided silicon dioxide grains 11, poly ethylene glycol 12 and an additive 13. The silicon dioxide grains 11 are made with a diameter of 50 nanometers to 500 micrometers. The poly ethylene glycol 12 is made with a molecular weight of 400 to 6000. The additive 13 may be ethanol or propanol. The silicon dioxide grains 11, the poly ethylene glycol 12 and the additive 13 are stirred and therefore mixed with one another evenly to provide a liquid mixture 1. The ratio of the silicon dioxide grains 11 over the poly ethylene glycol 12 is 20% wt to 60% wt.

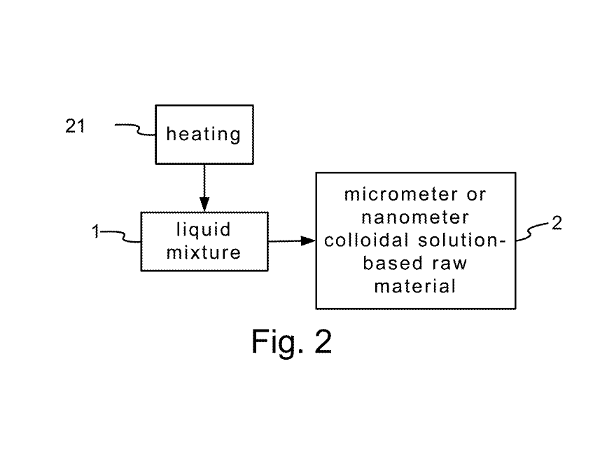

Referring to FIG. 2, at 21, the liquid mixture 1 is heated so that the additive 13 is evaporated and removed from the liquid mixture 1. Thus, there is provided a micro- or nano-colloidal solution-based raw material 2.

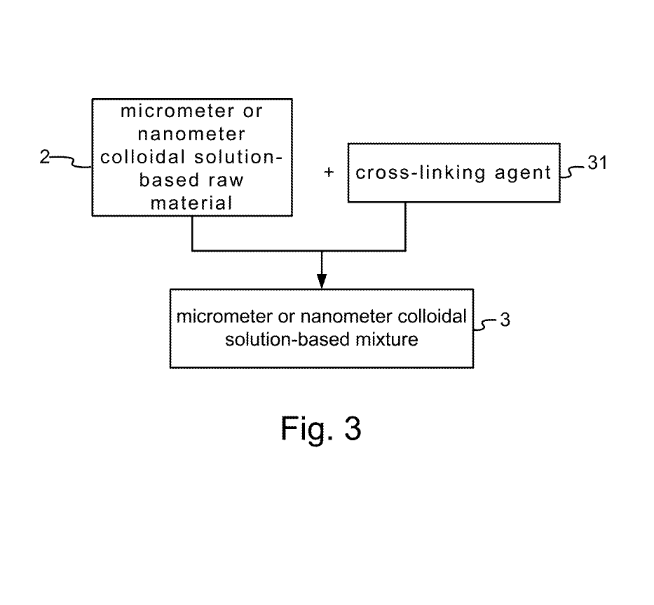

Referring to FIG. 3, a cross-linking agent 31 is added into the micro- or nano-colloidal solution-based raw material 2 to provide a micro- or nano-colloidal solution-based mixture 3. The cross-linking agent 31 may be an acrylic monomer or a polymer.

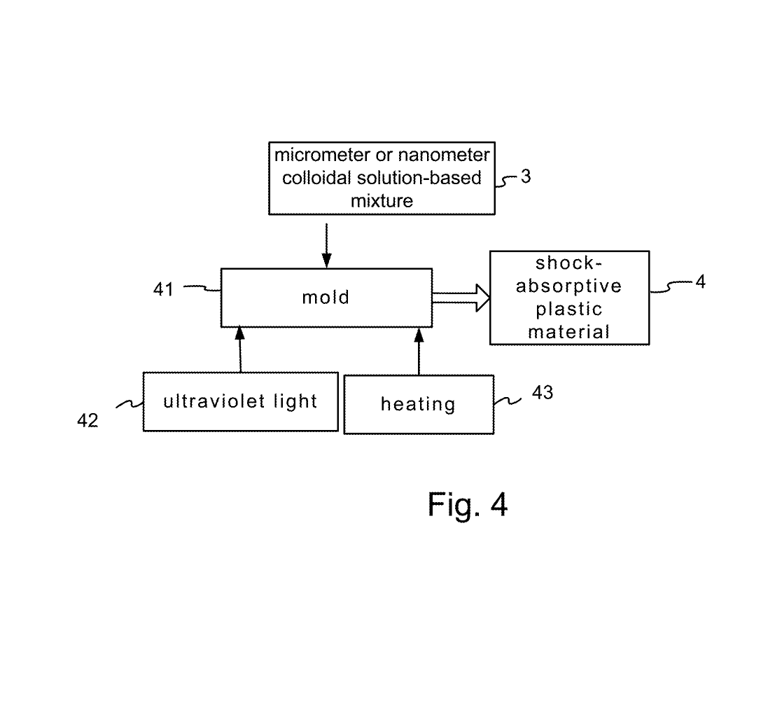

Referring to FIG. 4, the micro- or nano-colloidal solution-based mixture 3 is filled in a mold 41. The mold 41 is made of metal that stands 200 degrees centigrade to 350 degrees centigrade. Passivation may be executed on the surface of the mold 41 for easy release of a molded product from the mold 41 at a later stage. The mold 41 is irradiated by ultraviolet light 42 or heating 43 so that the micro- or nano-colloidal solution-based mixture 3 is cured and shaped. Thus, the micro- or nano-colloidal solution-based mixture 3 is molded to a shock-absorptive plastic material 4. The heating 43 to the mold 41 is used to 150 degrees centigrade to 190 degrees centigrade. The irradiation of the mold 41 by the ultraviolet light 42 is used to 1 to 2 hours.

Before the manufacturing of the shock-absorptive plastic material 4, a simulating software program such as LS-DYNA is used for mold-building, stress analysis and modification based on a shock-absorption specification and an available space. Finally, a high-G impact test is executed to verify the shock-absorptive performance of the shock-absorptive plastic material 4.

For example, the shock-absorptive plastic material 4 is made a shock-absorption pad that is 8 mm thick and tested. It has been proven that the shock-absorption pad absorbs at least 85% of an impact of 100,000G/25 μs. Furthermore, as the shock-absorptive plastic material 4 is subject to a shearing force, the inherent hydrogen bond works to pull the silicon dioxide grains 11 together to increase the viscosity of shock-absorptive plastic material 4. The shock-absorptive plastic material 4 is useful in absorbing heavy and high-frequency impacts.

For example, the shock-absorptive plastic material 4 can be used in a piece of weapon such as a missile to protect components of the missile from physical damages caused by heavy impacts when the missile hits a target. The shock-absorptive plastic material 4 can be used in a sports gear such as an insole, a bat, a club and a racket. The shock-absorptive plastic material 4 can be used for medical care such as protective clothes. The shock-absorptive plastic material 4 can be used wherever shock-absorption is needed such as a helmet and a bumper.

The shock-absorptive plastic material 4 exhibits at least two advantages. At first, the manufacturing of the shock-absorptive plastic material 4 is efficient and inexpensive. Secondly, the shock-absorptive plastic material 4 can be used in a wide variety of products in the arms industry, sports industry, medical industry and traffic industry for example.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for making a shock-absorptive plastic material including the steps of:
providing a liquid mixture 1 via mixing silicon dioxide grains 11, poly ethylene glycol 12 and an additive 13 evenly;
providing a colloidal solution-based raw material 2 via heating the liquid mixture 1 to evaporating and removing the additive 13;
providing a colloidal solution-based mixture 3 via adding a cross-linking agent 31 into the colloidal solution-based raw material 2; and
molding the colloidal solution-based mixture 3 into a shock-absorptive plastic material 4 via filling the colloidal solution-based mixture 3 in a mold 41 and irradiation of the mold 41 by the ultraviolet light 42 or heating the mold 41 to heat and cure the colloidal solution-based mixture 3.

2. The method according to claim 1, wherein the silicon dioxide grains 11 are made with a diameter of 50 nanometers to 500 micrometers.

3. The method according to claim 1, wherein the poly ethylene glycol 12 is made with a molecular weight of 400 to 6000.

4. The method according to claim 1, wherein the additive 13 is selected from the group consisting of ethanol or propanol.

5. The method according to claim 1, wherein the silicon dioxide grains 11 are mixed with the poly ethylene glycol 12 at a ratio of 20% wt to 60% wt.

6. The method according to claim 1, wherein the cross-linking agent 31 is selected from the group consisting of an acrylic monomer or a polymer.

7. The method according to claim 1, wherein the mold 41 is made of metal that stands 200 degrees centigrade to 350 degrees centigrade.

8. The method according to claim 1, wherein the step of molding the colloidal solution-based mixture 3 into the shock-absorptive plastic material 4 includes the step of executing passivation on the mold 41 to facilitate later release of the shock-absorptive plastic material 4 from the mold 41.

9. The method according to claim 1, wherein the step of molding the colloidal solution-based mixture 3 into the shock-absorptive plastic material 4 includes the step of casting ultraviolet light 42 onto the mold 41 or to heat the mold 41 to 150 degrees centigrade to 190 degrees centigrade for 1 to 2 hours.
